(19) United States
(12) Patent Application Publication
(10) Pub. No.: US 2010/0060628 A1
(43) Pub. Date: Mar. 11, 2010

(54) IN-PLANE SWITCHING ELECTROPHORETIC COLOUR DISPLAY

(75) Inventors: Kars-Michiel Hubert Lenssen, Eindhoven (NL); Patrick John Baesjou, Eindhoven (NL); Martinus Hermanus Wilhelmus Maria Van Delden, Eindhoven (NL); Sander Jurgen Roosendaal, Eindhoven (NL); Leon Wilhelmus Godefridus Stofmeel, Eindhoven (NL); Alwin Rogier Martijn Verschueren, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/516,694

(22) PCT Filed: Nov. 27, 2007
(86) PCT No.: PCT/IB2007/054799

§ 371 Date: May 28, 2009

(30) Foreign Application Priority Data
Nov. 30, 2006 (EP) 06125063.5

(51) Int. Cl. G09G 3/34; G06F 3/038

(52) U.S. Cl. 345/214; 345/107

(57) ABSTRACT

The invention relates to an electrophoretic color display panel, the display panel comprising at least one pixel (10, 12), the at least one pixel (10, 12) comprising a layer cavity (18ab) containing a suspension with a first set of charged particles (24a) having a first optical property and a second set of charged particles (24b) having a second optical property, and a pair of control electrodes (20a, 20b) arranged adjacent to the layer cavity (18ab), such that charged particles (24a, 24b) are essentially in-plane displaceable in an in-plane direction within the layer cavity (18ab) upon application of a control voltage over the electrode pair, wherein the in-plane distribution of charged particles (24a, 24b) having first and second optical properties in the layer cavity (18ab) depends on at least one of a differing control property additional to any polarity difference of the charged particles (24a, 24b) for each set of charged particles, or at least one additional electrode arranged adjacent to the layer cavity, wherein the electrode pair (20a, 20b) and the at least one additional control electrode are arranged essentially outside of a viewing area (26) of the at least one pixel (10, 12), such that a composite optical property of at least a portion of the at least one pixel (10, 12) is controllable. According to the invention, the control electrodes will be arranged at essentially the outer ends, or arranged in-plane, at a peripheral, of a prolonged layer cavity, such that the particles move in an in-plane direction within the layer cavity when the control voltage is applied. This facilitates the handling of the pixel since the layer cavity can be reached from essentially the outside of the pixel. Another advantage is that since only a minor part of the pixel area has to be covered with an electrode material the total transmission and thus the brightness of the pixel can be optimized.

### FIELD OF THE INVENTION

The invention relates to an electrophoretic color display panel for displaying an image.

### BACKGROUND OF THE INVENTION

An example of an electrophoretic color display panel is disclosed in U.S. Pat. No. 6,680,726. More precisely, U.S. Pat. No. 6,680,726 relates to a transmissive color electrophoretic display incorporated with a backlight. The display has a plurality of laterally adjacent pixels. Each pixel is comprised of two or more cells which are vertically stacked, one directly above the other on the horizontal surface of a panel located at the rear or bottom of the stacks. Each cell in a stack also has laterally adjacent like cells which together form a layer of cells in the display. Between each cell, there is a light-transmissive window. The cells contain a light-transmissive fluid and charged particles that can absorb a portion of the visible spectrum, with each cell in a stack containing particles having a color different from the colors of the particles in the other cells in the stack. The color of a pixel is determined by the portion of the visible spectrum originating from the backlight that survives the cumulative effect of traversing each cell in the stack. Such a display is usually referred to as a color subtractive display. Suitable cell colors for the display in U.S. Pat. No. 6,680,726 include cyan (C), magenta (M) and yellow (Y), yielding a three layer display. In CMY, magenta plus yellow produces red, magenta plus cyan makes blue and cyan plus yellow generates green.

The amount and color of the light transmitted by each cell is controlled by the position and the color of the pigment particles within the cell. The position, in turn, is directed by the application of appropriate voltages to electrodes of the cell, where each of the cells comprises collecting wall electrodes and a counter electrode. When the pigment particles are positioned in the path of the light that enters the cell, the particles absorb a selected portion of this light and the remaining light is transmitted through the cell. When the pigment particles are substantially removed from the path of the light entering the cell, the light can pass through the cell and emerge without significant visible change. The light seen by the viewer, therefore, depends on the distribution of particles in each of the cells in the vertical stacks. Since each of the cells in the stack occupy the same lateral area as the pixel itself, the transmission efficiency can be significantly higher than that of solutions that rely on a side-by-side arrangement of subpixels to generate color.

However, a problem with the display disclosed in U.S. Pat. No. 6,680,726 is that the counter electrode is arranged essentially centrally in the cell, having an electrical connection through the appropriate underlying, stacked, cells. This complicates the fabrication of cell, therefore increasing the production cost of the display panel. Furthermore, the use of one layer per color, resulting in at least three layers for a CMY display, may result in alignment issues when producing the display panel.

### SUMMARY OF THE INVENTION

There is therefore a need for an improved electrophoretic color display panel, more specifically an electrophoretic color display that overcomes or at least alleviates the problem with the positioning of electrodes in a cell for such an electrophoretic display panel.

The above object is met by a novel electrophoretic color display panel comprising at least one pixel, the at least one pixel comprising a layer cavity containing a suspension with a first set of charged particles having a first optical property and a second set of charged particles having a second optical property, and a pair of control electrodes arranged adjacent to the layer cavity, such that charged particles are essentially in-plane displaceable in an in-plane direction within the layer cavity upon application of a control voltage over the electrode pair, wherein the in-plane distribution of charged particles having first and second optical properties in the layer cavity depends on at least one of a differing control property additional to any polarity difference of the charged particles for each set of charged particles, or at least one additional electrode arranged adjacent to the layer cavity, wherein the electrode pair and the at least one additional control electrode are arranged essentially outside of a viewing area of the at least one pixel, such that a composite optical property of at least a portion of the at least one pixel is controllable.

Generally, when applying a control voltage over an electrode pair arranged with a layer cavity containing a suspension of charged particles, particles having for example a positive charge will start to move towards an electrode having an opposite polarity, i.e. a negative polarity. However, it is not straightforward to achieve controllability of the distribution of different sets of charged particles in such an arrangement. This is according to the invention solved by selecting at least one of at least a different control property for each of the different sets of particles additional to any polarity difference for each of the sets of charged particles, or at least one additional electrode arranged adjacent to the layer cavity. Through application of a control voltage over the electrode pair, and alternatively the at least one additional control electrode, it is thereby possible to control the distribution of the different sets of particles in the layer cavity, thereby changing the composite optical property of the layer cavity.

According to the invention, the control electrodes will be arranged essentially outside of a viewing area of the pixel, at the outer ends, or arranged in-plane, at a peripheral, of the prolonged layer cavity, such that the particles move in an in-plane direction within the layer cavity when the control voltage is applied. This facilitates the handling of the pixel since the layer cavity can be reached from essentially the outside of the pixel. Another advantage is that since the control electrodes are arranged essentially outside of a viewing area only a minor part of the pixel area has to be covered with an electrode material. Hence, the total transmission and thus the brightness of the pixel can be optimized. The expression “viewing area” is in the context of this application understood to mean the portion of the surface of a pixel that can change its composite optical state as perceived by a viewer looking at the display panel.

Preferably, the at least one pixel further comprises another layer cavity being stacked with the layer cavity, wherein said another layer cavity contains a suspension with a third set of charged particles having a third optical property and a fourth set of charged particles having a fourth optical property, each set of charged particles differing in at least one control property additional to any polarity difference for each of the sets of charged particles. When arranging at least two layer cavities in a stack, where each of the layer cavities comprises a suspension of at least two different sets of charged particles, it is thus possible to change the composite optical property of at least a portion of the total pixel. The expression “composite optical property” is in the context of this application understood to mean the total color of a layer cavity or of the total pixel, i.e. the color perceived by a viewer looking at the display panel.

Even though the control property for each of the different sets of charged particles in the layer cavity has to be different, it is not necessary that these control properties differ from the control properties in said another layer cavity, as long as the control properties for the different sets of charged particles in said another layer cavity are different from each other. However, it is possible to use the same control properties for both the sets of charged particles if at least an additional control is included with said another layer cavity. The alignment of stacked layer cavities according to this embodiment is facilitated since the electrodes of all layer cavities easily can be accessed from the outside of the layer cavities, without the need for a counter electrode essentially centrally in the cell. Furthermore, in comparison to prior art, by using at least two different sets of charged particles having different optical properties in each layer cavity, it is possible to minimize the number of necessary layers to achieve for example a four color CMYK-display panel.

Generally both the layer cavities have the same structure and functionality. However, it would according to the invention be possible to arrange said another layer cavity such that it is possible to move the particles in the different layer cavities at 90 degrees with respect to each other (i.e. charged particles not in-plane displaceable in an in-plane direction in said another layer cavity). For example, in a stack of two layer cavities, the bottom layer can be rotated by 90 degrees with respect to the top layer. Further embodiments may be envisioned where this angle is different than 90 degrees, for example 60 or 30 degrees.

In an embodiment, the at least one pixel comprises a first pair of control electrodes arranged with the layer cavity, and a second pair of control electrodes arranged with said another layer cavity. This facilitates the separate control of the composite optical property for each of the layer cavities, and thus the control of the total composite optical property for the total pixel, e.g. switching between different optical states. Accordingly, it is possible to switch each layer cavity of the pixel between at least four different states, e.g. a first state where all the charged particles are “collected” close to the electrodes, a second mixed state where both sets of different particles are dispersed in the layer cavity, a third state where the first set of particles are dispersed and the second set of particles are collected at a control electrode, and a fourth opposite state where the second set of particles are dispersed and the first set of particles are collected at a control electrode. Additionally, intermediate states are possible, e.g. from 0 to maximum in 4, 8, 16, 32, 64, 128, 256 or more steps.

Furthermore, it is possible to minimize the electrical field influence from one layer cavity on the other layer cavity by arranging the electrodes for one layer as far away as possible from the other layer cavity. For example, in one implementation, the control electrodes of the prolonged layer cavity are arranged in-plane adjacent to the side being opposite to the plane facing said another prolonged layer cavity, and the control electrodes of said another prolonged layer cavity are arranged correspondingly on the other side of said another prolonged layer cavity. However, alternatively, the first and the second sets of control electrodes can be arranged on respective sides of a common substrate sandwiched between the layer cavity and said another layer cavity, which further facilitates the fabrication of the display panel.

When charged particles moves towards the control electrodes, the distribution of particles will change, and the charged particles are compressed at a small fraction of the surface of the layer cavity, such that particles in close proximity to the electrodes are less visible. Preferably, at least one layer is provided with light shields covering the electrodes, which further minimizes the visibility of the compressed particles. The size of the light shields are preferably selected to be as small as possible to maximize the active portion of the pixel, i.e. the viewing area of the pixel. Thereto, the light shields are used to ensure that the color of the “collection area” (i.e. opposite to the viewing area) does not change depending on the state of the pixel. However, light shields could also be arranged together with all layers. It is possible to select the different sets of charged particles in at least one of the layers to have different, or the same, polarity. Such a selection can be based on implementation of the pixel, e.g. due to different types of optical properties of the charged particles. However, as described above, it is necessary to differentiate the control properties for different sets of charged particles in one layer cavity and/or include an additional control electrode. Preferably, the control properties for the different sets of particles in each of the layer cavities are selected to have either different electrophoretic mobilities, different threshold fields, different magnitude of the charge, or a combination thereof. As in relation to the polarity, the control properties may be selected based on implementation of the pixel, e.g. due to different types of optical properties of the charged particles.

Preferably, one of the layer cavities mainly affects the luminance of the display panel, and another of the layer cavities mainly affects the chrominance of the display panel. Furthermore, in one preferred embodiment the first type of particles comprise yellow colored particles, the second type of particles comprise cyan colored particles, the third type of particles comprise black colored particles, and the fourth type of particles comprise magenta colored particles. The person skilled in the art understands that each of the layer cavities can comprise suspensions with different combinations of colored particles. For example, the layer cavity comprising the third and the fourth set of colored particles can be arranged to comprise a combination of red and magenta, blue and magenta, or red and blue particles.

In a preferred embodiment, the display is a reflective display panel. Such a reflective display panel relies on the ambient light, e.g. external natural or artificial light sources, and is generally operated in well lit locations. A reflective display panel according to this embodiment further comprises a reflector arranged near or at the bottom of the vertical stack, and a layer cavity mainly affecting the luminance is sandwiched between a layer cavity mainly affecting the chrominance and the reflector. When selecting the layer cavity to comprise yellow and cyan particles, and said another layer cavity to comprise black and magenta colored particles, the reflector is preferably selected to be essentially white. In this case, a five color system can be achieved, where the mixing of two colors are done in the layer cavity, the mixing of another two colors are done in said another layer cavity, while at the same time having a white “background”. Such a five color system is similar to a four color print on a white paper.

In another preferred embodiment, the display is a transmissive display panel further comprising a backlight arranged at the bottom of the vertical stack, and a layer cavity mainly affecting the chrominance is sandwiched between the backlight and a layer cavity mainly affecting the luminance. A transmissive display panel is well suited for use indoors under artificial lighting, and finds its use in e.g. portable computers and lab instruments.

As understood by the person skilled in the art, the display panel described above is advantageously used as a substitute component in for example, but not limited to, a direct-view LCD (liquid crystal display) or an LCD-projector for TV application and/or monitor application.

### BRIEF DESCRIPTION OF THE DRAWINGS

Examples of the invention will now be described in detail with reference to the accompanying drawings, in which:

FIG. 1a-1d are side sectional views of an exemplary layer cavity of a pixel comprised in a display panel according to an embodiment of the present invention;

FIG. 2a-2b are side sectional view of a pixel from FIG. 1 arranged in a reflective display panel; and

FIG. 3 illustrates a side sectional view of a pixel from FIG. 1 arranged in a transmissive display panel.

It should be noted that these figures are diagrammatic and not drawn to scale. Relative dimensions and proportions of parts of these figures have been shown exaggerated or reduced in size, for the sake of clarity and convenience in the drawings.

### DETAILED DESCRIPTION OF THE EMBODIMENTS

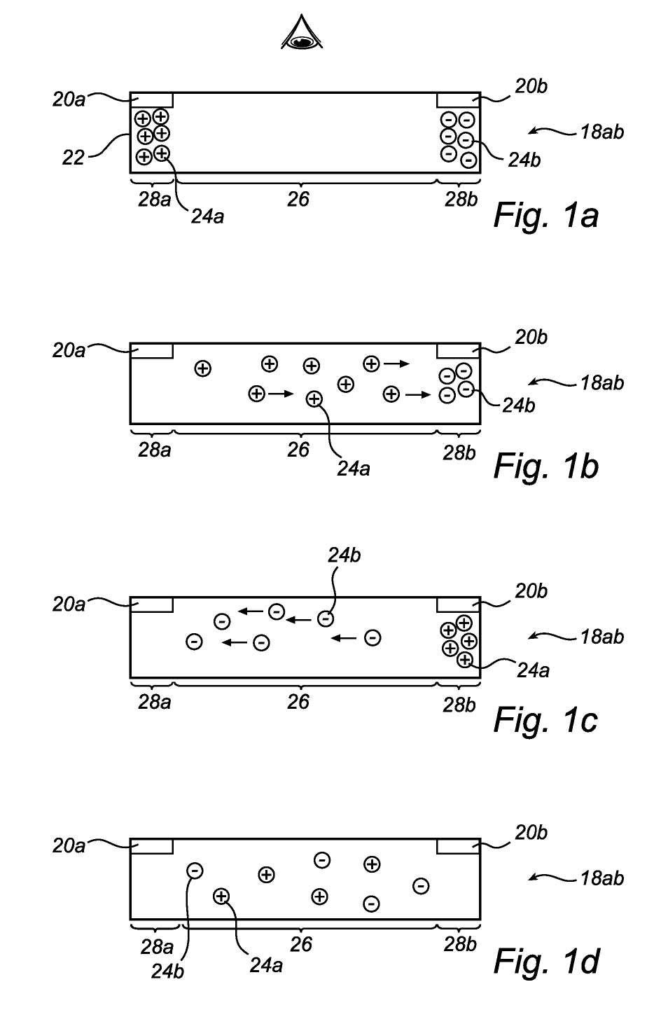

Referring to the drawings and to FIG. 1a-1d in particular, there is depicted a layer cavity 18ab for use in a color subtractive electrophoretic display according to an embodiment of the present invention. In FIG. 1, the layer cavity 18ab comprises two addressable control electrodes 20a and 20b. The electrodes 20a and 20b are preferably placed at opposite corners of the layer cavity 18ab, in collector areas 28a, 28b, outside of the viewing area 26 of the pixel 10. Alternatively, they can be placed along opposite side walls 22 of the layer cavity 18ab. The suspension of layer cavity 18ab further comprises two different sets of charged particles 24a and 24b, which except for color (e.g. optical property) differ in at least one other control property. In this example, one set of particles comprise cyan particles 24a having a positive charge and high mobility, while the other set of particles comprise yellow particles 24b having a negative charge and low mobility. By appropriately changing the voltages Va, Vb of the electrodes 20a and 20b (voltage level, duration, etc.), the layer cavity 18ab can switch between at least four states. In the first state (FIG. 1a), Va=−V and Vb=+V, whereby the cyan particles 24a are attracted by the electrode 20a to the collector area 28a and the yellow particles 24b are attracted by the electrode 20b to the collector area 28b. In this state, the layer cavity 18ab is essentially transparent, and any light striking the layer cavity 18ab will pass through it virtually unchanged.

Thereafter, the field is reversed. If the pulse is short, the viewing area 26 will be occupied by the quick cyan particles 24a only (FIG. 1b), while the slower yellow particles 24b remain at or close to the collector area 24b. In this second state, for input of white light, the layer cavity 18ab will appear cyan to a viewer.

On the other hand, if the pulse is long, the quick cyan particles 24a will be collected at the collector area 24b (FIG. 1c), while the viewing area 26 will be occupied by the slower yellow particles 24a only. Therefore, in this third state, the layer cavity 18ab will appear yellow to a viewer.

Finally (FIG. 1d), by applying an intermediate pulse (alternatively in combination with some AC shaking to promote a more homogeneous distribution), a mixed state may be achieved in which all particles 24a and 24b are distributed throughout the layer cavity 18ab in the viewing area 26. In this fourth state, the layer cavity 18ab will appear green (due to the mixing of yellow and cyan) to a viewer.

Optionally, each electrode 20 can be provided with a light shield (not shown), as discussed hereinbefore. To avoid that voltages applied in a layer cavity do not lead to disturbing field lines in other layer cavities, the dielectric constant and conductivity of the substrate, electrode, suspension or other elements of the layer cavity should be selected appropriately.

Furthermore, it is also possible to select the control properties for the different sets of particles to instead of having different mobility to have different threshold field. For example, in such an implementation, where the different set of particles have opposite charge, a first set of particles has a lower threshold than the second set of particles. A first state (as compared to FIG. 1a) is achieved by applying a field that is higher than the threshold of both particles, and thus the particles are collected at the electrodes and the viewing area 26 of the pixel is clear. This is also a “reset” state from which the other states are driven.

To only drive the first sets of particles into the field of view (FIG. 1b) it is sufficient to apply a field which is lower than the threshold field for the second set of particles. Furthermore, to obtain a state with both particles in the field of view (FIG. 1d), a field larger than both thresholds is applied, long enough for both different sets of particles to move into the viewing area 26 but not being collected at the opposite electrodes. From this mixed state, it is possible to “collect” the particles with the lowest threshold at one of the collector electrodes and thus achieve the fourth state (FIG. 1c) with only the second set of particles in the viewing area 26.

Also, other properties in addition to charge and mobility that can be utilized to control the different color particles in each layer cavity include charge magnitude, bi-stability, or combinations thereof Also, additionally or instead, at least an additional control electrode could be provided to enhance the controllability of the different color particles.

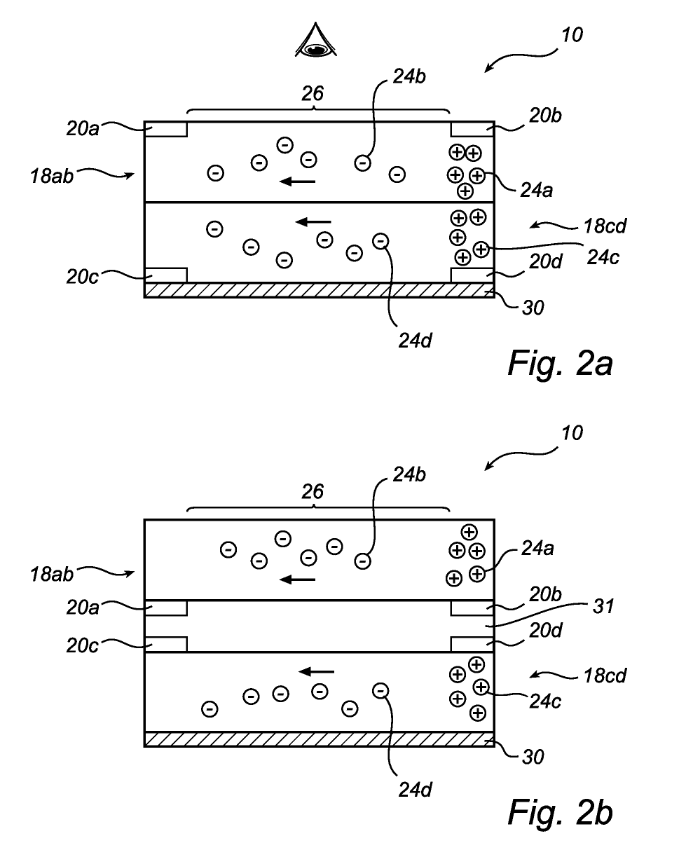

FIG. 2a illustrates the structure of a two-layer pixel 10 arranged in a reflective display panel. The pixel 10 comprises a first layer cavity 18ab as discussed in relation to FIG. 1a-1d, a different layer cavity 18cd (having similar structure as the first layer cavity 18ab), and a reflector 30. In the pixel 10, a layer cavity mainly affecting the luminance is arranged closest to the reflector 30. Thus, the different layer cavity 18cd comprises a suspension of black particles 24c having a positive charge and high mobility, and magenta particles 24d having a negative charge and low mobility, and to accommodate the aspect of a luminance affecting layer closest to the reflector, the layer cavity 18cd is sandwiched between the layer cavity 18ab and the reflector. As in FIG. 1a-1d, the layer cavity 18ab, i.e. the layer cavity mainly affecting the chrominance of the pixel 10, comprises a suspension of cyan particles 24a having a positive charge and high mobility, and yellow particles 24b having a negative charge and low mobility. Preferably, the layer cavity 18cd mainly affecting the luminance contains particles with an absorption close to or around 550 nm.

For simplicity of discussion of FIG. 2a, both the layer cavities 18ab and 18cd are in a similar state as is discussed in relation to FIG. 1c, such that the viewing area 26 will be occupied only by the slower yellow particles 24a in the layer cavity 18ab, and only by the slower magenta particles 24d in the layer cavity 18cd. In such a case the mixing of the yellow particles 24a and the magenta particles 24d will produce a state where a red color is perceived by a viewer. In the present example the reflector is selected to have a white color, thus providing the possibility to produce a five color system (CMYK+white).

By mixing yellow, magenta and cyan, it is possible to produce a composite optical property of the pixel, e.g. color, that approximates black. However, a mixture of practical cyan, magenta, and yellow pigments is not pure black, but a dark murky color. By introducing the black particles 24c it is however possible to produce pure black. This is especially advantageous if arranging the display panel in for example a full color electronic paper.

FIG. 2b illustrates an alternative implementation of a two-layer pixel 10 arranged in a reflective display panel. The pixel 10 comprises two layer cavities 18ab, 18cd as discussed in relation to FIG. 1a-1d and 2a, and a reflector 30. However, in FIG. 2b the control electrodes 20a-20d have been arranged onto a common substrate 31 that has been sandwiched between the two layer cavities 18ab and 18cd. The common substrate 31 has several advantages. First, it facilitates the fabrication of the pixel, as the critical step of producing electrode structures needs to be done only on a single substrate, and thus alignment of the different electrodes is made easier. Further, conducting lines from the edge of the display to the pixel electrodes are all on the same substrate, which makes production and bonding to external driving electronics easier. Further, if both electrodes are non-transparent (to act as a light shield), it is an advantage if they are close together, for reasons of preventing parallax and to reduce the light loss in the display. Also the dielectric properties of the center substrate may be chosen such that the electric field lines arising from each electrode set at opposing sides of the substrate do not or only to a small extend disturb the non-addressed medium layer. Further reduction of the cross-talk fields is possible in rotating one of the electrodes set over 90 degrees with respect to the other electrode sets at the opposing face. Thus the strongest disturbing fields only arise between the corners of crossing drive electrodes (one upon the other), and within the center substrate, but do not penetrate substantially into the layer cavities. Alternatively, the dielectric properties of the materials used may be chosen such that the electric fields arising from the first layer do extend into the second layer in a controlled manner, and this is used for driving the particles in the second layer prior to driving the particles in the first layer.

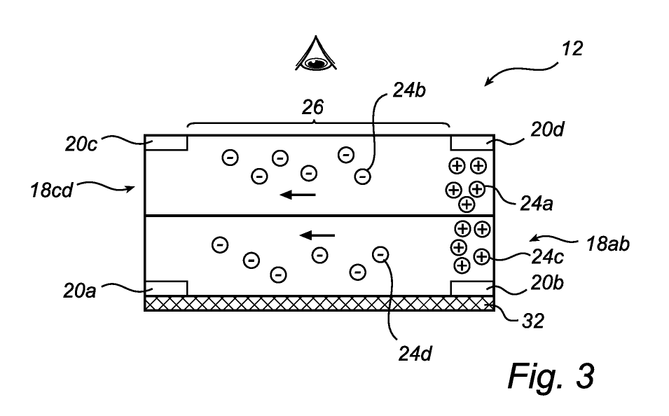

FIG. 3 illustrates a two-layer pixel 12 arranged in a two-layer transmissive display panel. The stacked two-layer pixel structure is similar to the structure illustrated in FIG. 2a, however the two different layer cavities 18ab, 18cd have changed position such that the layer cavity 18cd faces the viewer. Furthermore, the reflector 30 has been replaced by an active light source in the form of a backlight 32.

During operation of the pixel 12, the brightness of the pixel 12 is not only adjusted by the luminance layer (layer cavity 18cd, as is the case in FIG. 2a-2b), but also by adjusting the brightness of the backlight. It is thus possible to provide a full-color transmissive display panel having high brightness.

The transmissive display according to this embodiment has a six times higher transmissivity in the bright state than a corresponding LCD display with static color filters. This enables a smaller, less power consuming backlight to achieve the same front-of-screen luminance. Furthermore, the display can have more saturated colors, because—in contrast with the LCD panel—the brightness of the white state is not affected by the color saturation in the colored states. The standard LCD works with a fixed RGB color filter. The less saturated the red, green and blue parts of the color filter, the higher the brightness. The panel of this invention could also be used as a dynamic color filter in combination with an LCD layer or other type of display (plasma, OLED), enabling higher brightness and more saturated colors, while keeping the advantage of fast response speeds of the LCD display.

While the invention has been illustrated and described in detail in the drawings and foregoing description, such illustration and description are to be considered illustrative or exemplary and not restrictive; the inventions is not limited to the disclosed embodiments. Variations to the disclosed embodiments can be understood and effected by those skilled in the art in practicing the claimed invention, from a study of the drawings, the disclosure, and the appended claims. For example, instead of CMYK, other combinations of colored particles may be used, or the display may be of a transflective type, combining reflective and transmissive properties. The “color” of one of the particles may be the absorption of light in a non-visible part of the spectrum, for example UV or infrared light. Furthermore, even though the electrode pairs 20a-20b, and 20c-20d in FIG. 2a-2b, and in FIG. 3 are essentially vertically aligned with each other, this is not necessary for the invention. The placement of the different electrodes may instead be dependant on different implementation strategies for the display panel.

In the claims, the word “comprising” does not exclude other elements, and the indefinite article “a” or “an” does not exclude a plurality. The mere fact that certain measures are recited in mutually different dependent claims does not indicate that a combination of these measures cannot be used to advantage. Any reference signs in the claims should not be construed as limiting the scope.

1. An electrophoretic color display panel, said display panel comprising at least one pixel (10, 12), said at least one pixel (10, 12) comprising:
a layer cavity (18ab) containing a suspension with a first set of charged particles (24a) having a first optical property and a second set of charged particles (24b) having a second optical property; and
a pair of control electrodes (20a, 20b) arranged adjacent to the layer cavity (18ab), such that charged particles (24a, 24b) are essentially in-plane displaceable in an in-plane direction within the layer cavity (18ab) upon application of a control voltage over the electrode pair, wherein the in-plane distribution of charged particles (24a, 24b) having first and second optical properties in the layer cavity (18ab) depends on at least one of:
a differing control property additional to any polarity difference of the charged particles (24a, 24b) for each set of charged particles; or
at least one additional control electrode arranged adjacent to the layer cavity (18ab), wherein said electrode pair (20a, 20b) and said at least one additional control electrode are arranged essentially outside of a viewing area (26) of said at least one pixel (10, 12), such that a composite optical property of at least a portion of said at least one pixel (10, 12) is controllable.

2. A display panel according to claim 1, wherein said at least one pixel (10, 12) further comprises another layer cavity (18cd) being stacked with said layer cavity (18ab), wherein said another layer cavity (18cd) contains a suspension with a third set of charged particles (24c) having a third optical property and a fourth set of charged particles (24d) having a fourth optical property, each set of charged particles (24c, 24d), differing in at least one control property additional to any polarity difference for each of the sets of charged particles (24c, 24d).

3. A display panel according to claim 2, wherein said at least one pixel (10, 12) comprises a first pair of control electrodes (20a, 20b) arranged with the layer cavity (18ab), and a second pair of control electrodes (20c, 20d) arranged with said another layer cavity (18cd).

4. A display panel according to claim 2, wherein the first and the second set of control electrodes are arranged on respective sides of a common substrate sandwiched between the layer cavity and said another layer cavity.

5. A display panel according to claim 1, wherein at least one layer cavity is provided with light shields covering the electrodes, such that particles in close proximity to the electrodes are less visible.

6. A display panel according to claim 1, wherein the different sets of charged particles in at least one layer cavity have different polarity.

7. A display panel according to claim 1, wherein the different sets of charged particles in at least one layer cavity have
the same polarity.

8. A display panel according to claim 1, wherein the control properties of the different sets of particles in at least one layer cavity are selected to have different mobility.

9. A display panel according to claim 1, wherein the control properties of the different sets of particles in at least one layer cavity are selected to have different threshold fields.

10. A display panel according to claim 2, wherein one layer cavity mainly affects the luminance of the display panel, and another layer cavity mainly affects the chrominance of the display panel.

11. A display panel according to claim 2, wherein the first type of particles comprise yellow colored particles, the second type of particles comprise cyan colored particles, the third type of particles comprise black colored particles, and the fourth type of particles comprise magenta colored particles.

12. A display panel according to claim 2, wherein the display panel is a reflective display panel further comprising a reflector arranged near or at the bottom of the vertical stack, and a layer cavity mainly affecting the luminance is sandwiched between a layer cavity mainly affecting the chrominance and the reflector.

13. A display panel according to claim 12, wherein the reflector (30) is essentially white.

14. A display panel according to claim 2, wherein the display panel is a transmissive display panel further comprising a backlight arranged at the bottom of the vertical stack, and a layer cavity mainly affecting the chrominance is sandwiched between the backlight and a layer cavity mainly affecting the luminance.
